(19) United States
(12) Patent Application Publication
(10) Pub. No.: US 2026/0166979 A1
(43) Pub. Date: Jun. 18, 2026

(54) BATTERY MOUNTING STRUCTURE OF EV VEHICLE

(71) Applicant: ISUZU MOTORS LIMITED, Yokohama-shi (JP)

(72) Inventors: Masayuki HIRATA, Fujisawa-shi (JP); Kyosuke IWAMURO, Fujisawa-shi (JP)

(21) Appl. No.: 19/381,161

(22) Filed: Nov. 6, 2025

(30) Foreign Application Priority Data
Dec. 12, 2024 (JP) 2024-217640

(51) Int. Cl. B60K 1/04; B60L 50/60; B62D 21/03; B62D 27/06; B62D 29/00

(52) U.S. Cl. CPC B60K 1/04; B60L 50/66; B62D 21/03; B62D 27/065; B62D 29/008; B60K 2001/0438

(57) ABSTRACT

An object of the present disclosure is to provide a battery mounting structure of an EV vehicle that can reduce impact load on a battery pack from outside the vehicle and protect the battery pack. A battery mounting structure of an EV vehicle of the present disclosure, comprising: a plurality of panel components that are disposed below a floor panel of the vehicle and extend in a vehicle width direction so as to span between a pair of side members of a vehicle frame respectively, wherein the panel components are connected in a line along a vehicle longitudinal direction to constitute an under-panel that serves as a mounting base for a battery pack.

### RELATED APPLICATIONS

This application claims the benefit of priority of Japanese Patent Application No. 2024-217640 filed 12 Dec. 2024, the contents of which are incorporated herein by reference in their entirety.

### TECHNICAL FIELD

The present disclosure relates to a battery mounting structure of an EV vehicle.

### BACKGROUND ART

In a recent electric vehicle (hereinafter referred to as “EV vehicle” or “vehicle”), as a battery pack, which is driving battery, becomes longer and larger, a structure in which the battery pack is mounted below the floor panel has been considered (see, for example, PTL 1).

### CITATION LIST

### Patent Literature

PTL 1: Japanese Patent Application Laid-Open No. 2018-131136

### SUMMARY OF INVENTION

### Technical Problem

Incidentally, in the battery mounting structure of the vehicle according to conventional technology such as that disclosed in PTL 1, the battery pack is supported by battery side frames so as to span between a pair of side frames of the vehicle, and the lower side of the battery pack is exposed to the road-surface below the vehicle.

However, with this configuration, the battery pack may be subjected to an impact load from the road-surface side below the vehicle (e.g., interference with a rock, etc.) when the vehicle is driving on rough roads, etc. Such an impact load may cause deformation of the bottom outer wall of the battery pack.

Deformation of the battery pack must be avoided not only on the bottom outer wall but also on the side outer wall, so the battery mounting structure must be configured to protect the battery pack when the vehicle is subjected to an impact load from the left or right side (e.g., interference with a utility pole) in addition to an impact load from the road-surface side below the vehicle (e.g., interference with a rock, etc.).

On the other hand, in the recent EV vehicle, battery packs have become longer and larger due to demands for longer driving range due to demands such as ensuring driving range, and the design of the battery mounting structure is becoming increasingly difficult.

The present invention has been made in view of the above-mentioned problems, and an object of the present invention is to provide a battery mounting structure of an EV vehicle that can reduce an impact load on the battery pack from outside the vehicle and protect the battery pack.

### Solution to Problem

A main aspect of the present disclosure for solving the above-described problems is a battery mounting structure of an EV vehicle, comprising: a plurality of panel components that are disposed below a floor panel of the vehicle and extend in a vehicle width direction so as to span between a pair of side members of a vehicle frame respectively, wherein the panel components are connected in a line along a vehicle longitudinal direction to constitute an under-panel that serves as a mounting base for a battery pack.

### Advantageous Effects of Invention

According to the battery mounting structure of the EV vehicle of the present invention, it is possible to reduce the impact load on the battery pack from outside the vehicle and protect the battery pack.

### BRIEF DESCRIPTION OF DRAWINGS

FIG. 1 is a top view of a battery mounting structure of a vehicle according to one embodiment of the present invention.

FIG. 2 is a side view of a battery mounting structure of a vehicle according to one embodiment of the present invention.

FIG. 3 is a side view showing a mounted state of an under-panel to a side member of a vehicle according to one embodiment of the present invention.

FIG. 4 is a perspective view showing a mounted state of an under-panel to a side member of a vehicle according to one embodiment of the present invention.

FIG. 5 is a view showing a mounted state of a battery pack on an under-panel according to one embodiment of the present invention.

FIG. 6 is an exploded perspective view of a battery pack according to one embodiment of the present invention.

FIG. 7 is a side view showing a mounted state of a battery pack on an under-panel according to one embodiment of the present invention.

FIG. 8 is a perspective view showing a configuration of an under-panel according to one embodiment of the present invention.

FIG. 9 is a side view showing a configuration of an under-panel according to one embodiment of the present invention.

FIG. 10 is a diagram explaining a function of a battery mounting structure according to one embodiment of the present invention during impact occurrence.

FIG. 11 is a diagram explaining a function of a battery mounting structure according to one embodiment of the present invention during impact occurrence.

### DESCRIPTION OF EMBODIMENTS

Hereinafter, a preferred embodiment of the present invention will be described in detail with reference to the accompanying drawings. Note that, in the present specification and drawings, components having substantially the same functions are denoted by the same reference signs, and redundant descriptions are omitted thereby.

### Overall Configuration of Vehicle

Below, an example of a configuration of a battery mounting structure (hereinafter referred to as “battery mounting structure Ca”) for an EV vehicle (hereinafter referred to as “vehicle 1”) according to one embodiment of the present invention will be described.

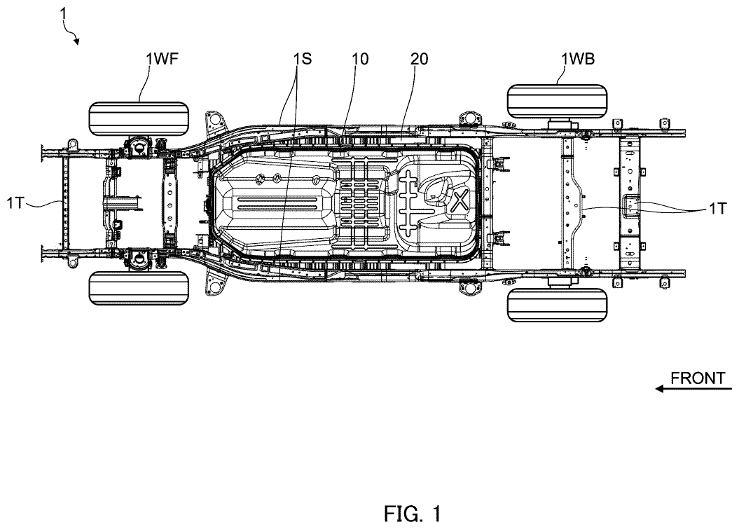

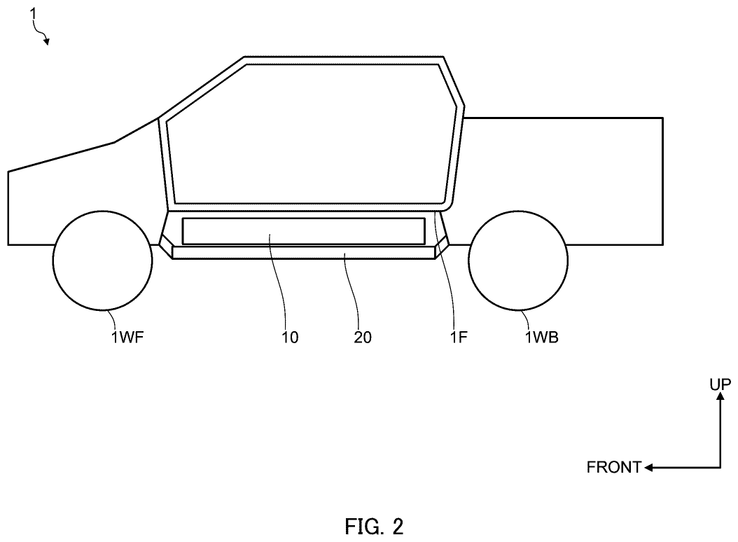

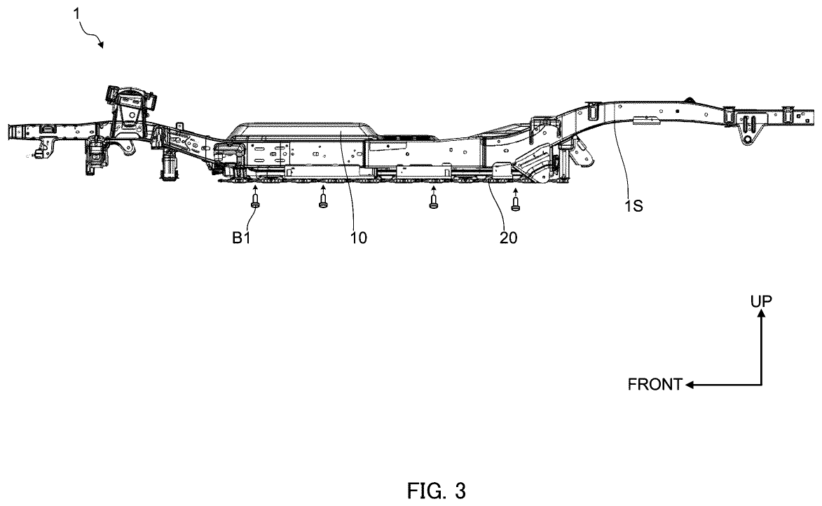

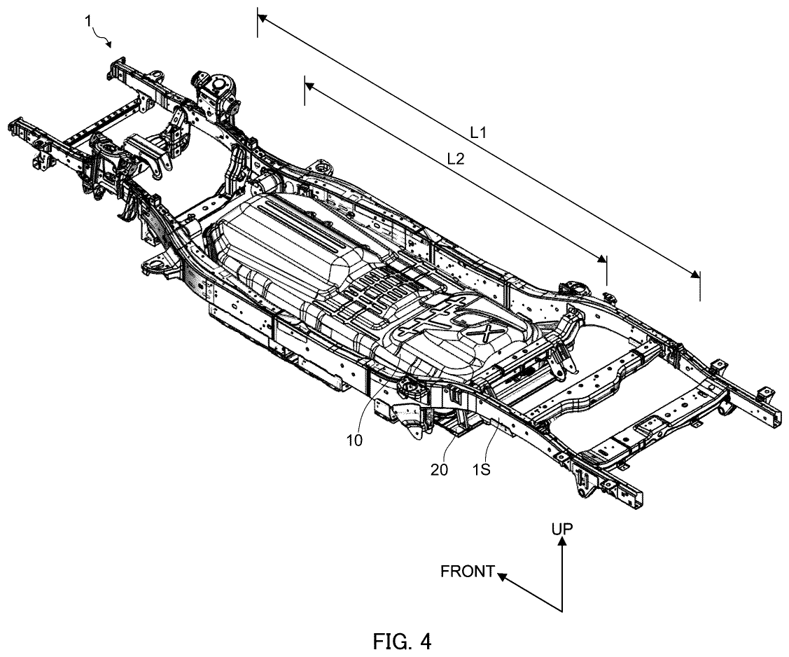

FIG. 1 is a top view of battery mounting structure Ca of vehicle 1. FIG. 2 is a side view of battery mounting structure Ca of vehicle 1. FIG. 3 is a side view showing the mounted state of under-panel 20 to side member 1S of vehicle 1. FIG. 4 is a perspective view showing the mounted state of under-panel 20 to side member 1S of vehicle 1.

Vehicle 1 includes battery pack 10 used as a driving power source, and under-panel 20 that supports battery pack 10 from the lower side of the vehicle body.

Vehicle 1 has, for example, a vehicle frame structure same as that of a typical passenger vehicle, and is equipped with a pair of side members 1S extending in the vehicle longitudinal direction of the vehicle body, a plurality of cross members 1T extending in the vehicle width direction, front wheel 1WF and rear wheel 1WB attached to the pair of side members 1S, and floor panel 1F that form the cabin on the pair of side members 1S.

Side member 1S is formed, for example, from steel materials with a cross-section that is approximately hat-shaped. Side member 1S is disposed in pairs on both the left and right sides of the body of vehicle 1 to form a body frame structure. Cross member 1T is disposed so as to span between the pair of side members 1S.

However, in vehicle 1 according to this embodiment, no cross member is disposed near the middle between front wheel 1WF and rear wheel 1WB. This is because, to accommodate long and large battery pack 10 under floor panel 1F, battery mounting structure Ca of vehicle 1 according to this embodiment adopts a configuration where under-panel 20 extends from near front wheel 1WF to near rear wheel 1WB in the vehicle longitudinal direction. In battery mounting structure Ca of vehicle 1 according to this embodiment, typically, under-panel 20 occupies area L2 that is at least half the length of area L1 between the positions of front wheel 1WF and rear wheel 1WB of vehicle 1 in the vehicle longitudinal direction (see FIG. 4).

Battery mounting structure Ca is constituted by under-panel 20 disposed on the lower side of the vehicle body of floor panel 1F, and under-panel 20 functions as a mounting base for battery pack 10. Under-panel 20 is disposed to cover substantially the entire bottom surface of battery pack 10, thereby functioning as an impact mitigation material for battery pack 10.

Under-panel 20 extends in the vehicle width direction to span between the pair of side members 1S, thereby also functioning as a reinforcing member that reinforces the strength between the pair of side members 1S.

Note that under-panel 20 is fastened and fixed to the lower side of side members 1S by bolt B1. Specifically, with under-panel 20 disposed on the lower side of side member 1S, bolt B1 is inserted from the lower side of under-panel 20 so that bolt B1 communicates with the mounting holes (not shown) formed in under-panel 20 and the mounting holes (not shown) of side member 1S. Then, bolt B1 is fastened between a nut welded coaxially around the mounting hole of side member 1S, thereby fixing the under-panel 20 to side member 1S.

Floor panel 1F is disposed on the pair of side members 1S and is fixed to the pair of side members 1S via rubber mounts (not shown). Floor panel 1F is disposed spaced above under-panel 20. That is, battery pack 10 is housed in the space between floor panel 1F and under-panel 20. Floor panel 1F is disposed with a certain clearance from battery pack 10.

### Configuration of Battery Pack 10

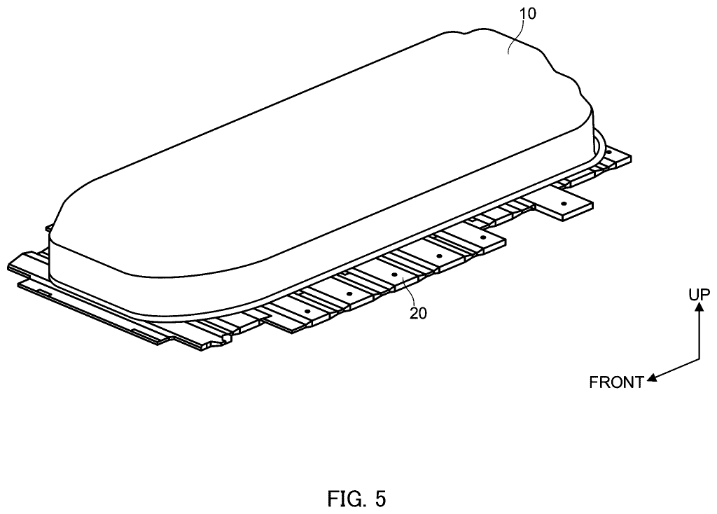

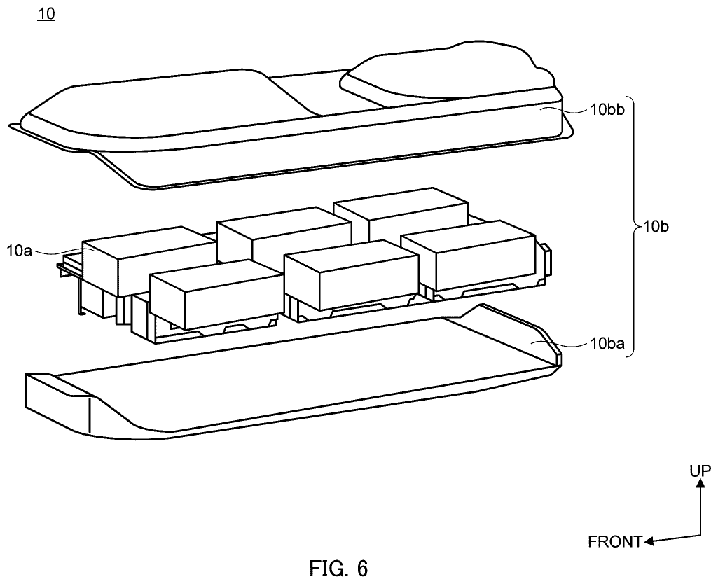

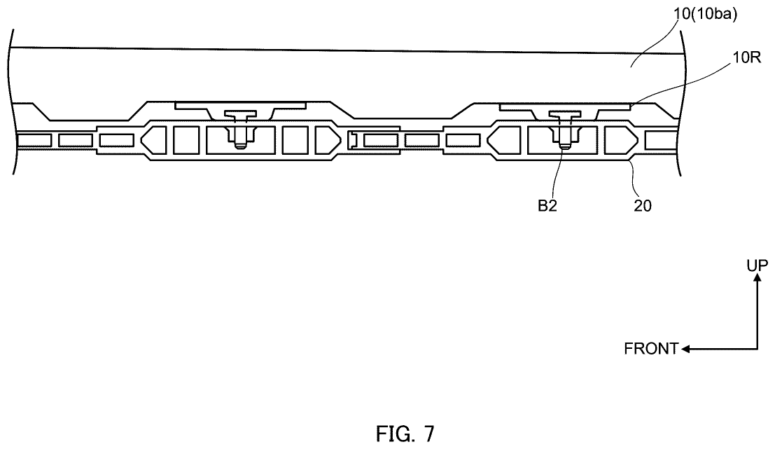

FIG. 5 is a view showing the mounted state of battery pack 10 on under-panel 20. FIG. 6 is an exploded perspective view of battery pack 10. FIG. 7 is a side view showing the mounted state of battery pack 10 on under-panel 20.

Battery pack 10 is composed of battery body 10a and exterior case 10b that houses battery body 10a.

Battery body 10a is, for example, a high-voltage (e.g., 200V class) lithium ion battery used as a driving power source.

Exterior case 10b is formed in a rectangular box shape using metal materials, for example. Exterior case 10b is constituted by tray 10ba on which battery body 10a is placed and cover member 10bb that covers battery body 10a from above.

Battery pack 10 (outer casing 10b) is disposed on under-panel 20 and is fixed to under-panel 20 with bolt B2. Specifically, bracket 10R is welded to the lower surface of tray 10ba of outer casing 10b, and bolt B2 (here, a stud bolt) is welded to bracket 10R, which is then fixed to under-panel 20 with a nut.

### Configuration of Under-Panel 20

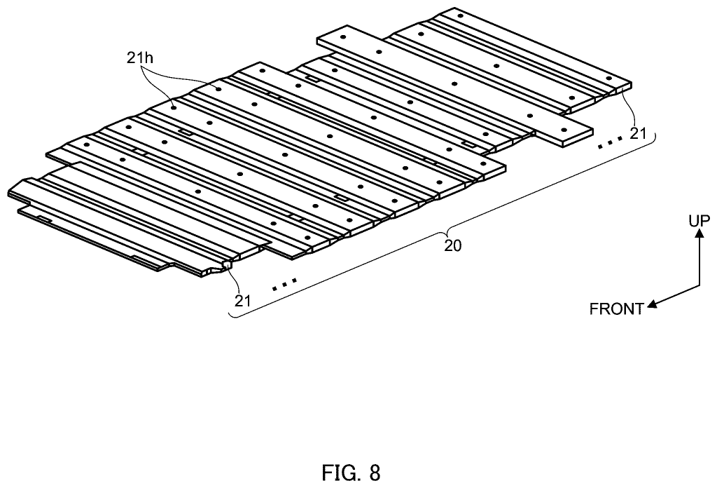

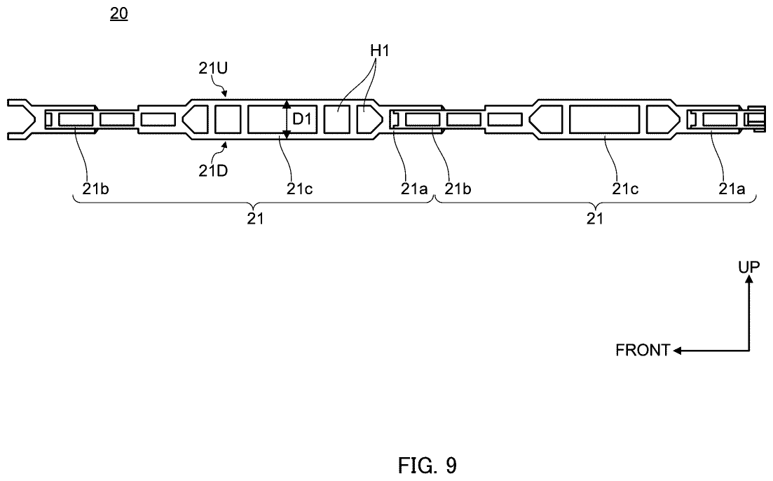

FIG. 8 is a perspective view showing the configuration of under-panel 20. FIG. 9 is a side view showing the configuration of under-panel 20.

Under-panel 20 functions as a mounting base for battery pack 10 and also as an impact buffer that protects battery pack 10 from impact loads from the road-surface side below vehicle 1. Under-panel 20 also functions as a reinforcing member that reinforces the strength between the pair of side members 1S. In other words, under-panel 20 protects battery pack 10 when an impact load is applied from the left or right side of vehicle 1.

Under-panel 20 is constructed by arranging and connecting a plurality of panel components 21 (eleven sheets in this embodiment) along the vehicle longitudinal direction, each panel component 21 extending in the vehicle width direction so as to span between a pair of side members 1S. The number of panel component 21 constituting under-panel 20 is designed so that the length of under-panel 20 in the vehicle longitudinal direction is longer than the length of battery pack 10 in the vehicle longitudinal direction.

Each panel component 21 is formed so that its length in the vehicle width direction is longer than the length of battery pack 10 in the vehicle width direction, and as described above, both ends of each panel component 21 in the vehicle width direction are fixed to the pair of side members 1S with bolt B1. The entire lower side of battery pack 10 is substantially covered by under-panel 20, and is not exposed to the road-surface below vehicle 1.

Each panel component 21 constituting under-panel 20 has substantially the same configuration.

Specifically, panel component 21 has upper plate 21U and lower plate 21D. Panel component 21 is configured such that upper plate 21U and lower plate 21D are connected to each other so as to form hollow portion H1 extending along the vehicle width direction therebetween. In other words, upper plate 21U and lower plate 21D are connected to each other so as to form a closed cross section.

More specifically, upper plate 21U and lower plate 21D are each formed with a thickness of, for example, 4 mm to 10 mm, and hollow portion H1 is formed with a thickness of, for example, 10 mm to 20 mm. Panel component 21 as a whole is formed with a thickness of, for example, 20 mm to 40 mm (thickness D1 in FIG. 9). Both upper plate 21U and lower plate 21D are plate-shaped and do not have any downward protrusions.

Hollow portion H1 extends, for example, so as to penetrate panel component 21 from one end to the other end in the vehicle width direction. Additionally, hollow portion H1 is divided into multiple sections, with vertical walls connecting upper plate 21U and lower plate 21D disposed at various locations along the vehicle longitudinal direction. In other words, the divided multiple sections of hollow portion H1 are aligned in a row along the vehicle longitudinal direction in a side view.

This configuration contributes to lightening panel component 21 while enhancing its strength. In other words, this configuration allows for a large cross-sectional second moment of inertia for the entire panel component 21, while using thin upper plate 21U and lower plate 21D. This ensures the bending strength of under-panel 20, reducing the deformation amount of under-panel 20 against impact loads from the road-surface side under vehicle 1 and from the left or right side of vehicle 1, thereby mitigating the impact on battery pack 10 from under-panel 20. Additionally, this allows under-panel 20 to effectively function as a reinforcing member that reinforces the space between the pair of side members 1S.

Moreover, according to this configuration, if there is an impact load from the road-surface side under vehicle 1 (e.g., interference with rocks), only lower plate 21D deforms due to the presence of hollow portion H1, while the deformation of upper plate 21U is suppressed. In other words, this allows under-panel 20 to absorb the impact energy from the road-surface side below vehicle 1 to battery pack 10.

Panel component 21 has either insertion protrusion 21a or receiving recess 21b at both ends in the vehicle longitudinal direction. Adjacent panel components 21 constituting under-panel 20 are welded and fixed in a state where insertion protrusion 21a of one panel component 21 is fitted into receiving recess 21b of the other panel component 21. Insertion protrusion 21a is a thin extension extending in the vehicle longitudinal direction from the main body of panel component 21, and receiving recess 21b is an opening extending in the vehicle longitudinal direction from the main body of panel component 21.

Here, the vertical thickness of the end of panel component 21 in the vehicle longitudinal direction (i.e., insertion protrusion 21a or the gripping recess 21b) is thinner than the vertical thickness of center portion 21c of panel component 21. As a result, when battery pack 10 is placed on under-panel 20, a partial space is formed between battery pack 10 and under-panel 20. This space functions as a margin when under-panel 20 deforms due to an impact load from the road-surface below vehicle 1, and suppresses the transmission of impact energy from the road-surface below the vehicle to battery pack 10. This configuration also corresponds to the uneven structure on the lower side (i.e., the bottom outer wall) of battery pack 10.

Panel component 21 is formed from, for example, lightweight and high-strength aluminum material. More specifically, panel component 21 is formed from aluminum extrusion material, with upper plate 21U and lower plate 21D integrally molded. Because the aluminum extrusion material can be molded into complex shapes easily, it is suitable for manufacturing components with complex shapes, such as panel component 21 of this embodiment.

In battery mounting structure Ca according to this embodiment, under-panel 20 is configured by connecting a plurality of panel components 21 for the following reasons.

First, under-panel 20 must be disposed so as to cover substantially the entire lower side of long and large battery pack 10, and also function as a reinforcing member that reinforces the strength between the pair of side members 1S. Therefore, under-panel 20 must be large enough to extend from front wheel 1WF to rear wheel 1WB in the longitudinal direction of vehicle 1. In reality, it is extremely difficult to manufacture under-panel 20 of this size from a single panel component 21 due to limitations in the aluminum extrusion manufacturing equipment, etc. From this perspective, under-panel 20 is configured by connecting a plurality of panel components 21.

In addition, by adopting the method of connecting a plurality of panel components 21 to form under-panel 20, it is possible to easily adjust the length of under-panel 20 in the vehicle longitudinal direction by adjusting the number of panel components 21. This makes it possible to use panel component 21 of the same configuration for vehicles of various wheelbases. Furthermore, by preparing a plurality of types of panel components 21 with different lengths in the vehicle width direction, it is also possible to adjust the length of each part of under-panel 20 in the vehicle width direction.

### Function of Battery Mounting Structure Ca During Impact Occurrence

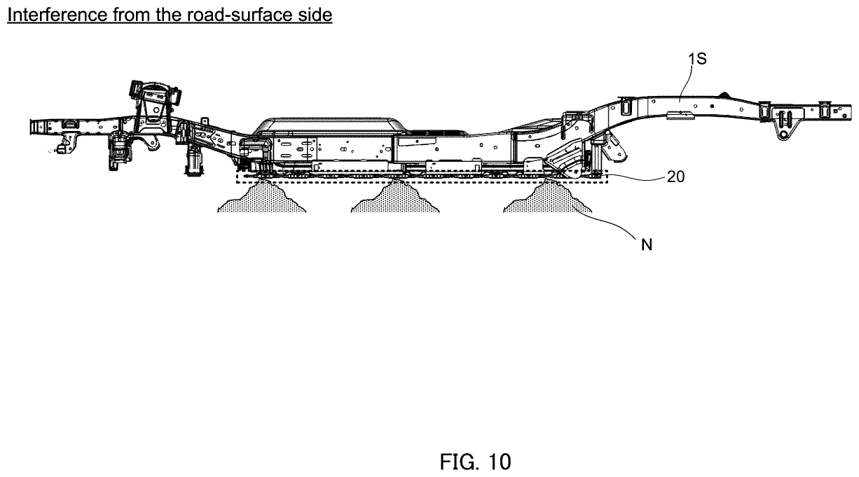

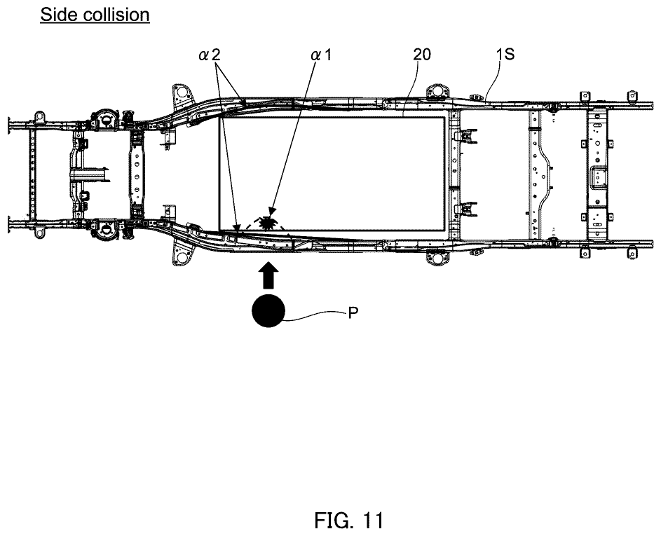

Next, the function of battery mounting structure Ca during impact occurrence will be explained with reference to FIG. 10 and FIG. 11. Here, the explanation will cover the case where, as shown in FIG. 10, road-surface interference object N such as protruding stones interfere with under-panel 20 during off-road driving, and the case where, as shown in FIG. 11, vehicle 1 side-collides with cylindrical pole P that extends vertically.

When road-surface interference object N interferes with under-panel 20, first, due to the presence of hollow portion H1, only lower plate 21D of under-panel 20 deforms, and deformation of upper plate 21U is suppressed. As a result, the impact energy from the road-surface side under vehicle 1 to battery pack 10 is absorbed by under-panel 20.

Here, when the impact load from road-surface interference object N to under-panel 20 is large, under-panel 20 as a whole (upper plate 21U and lower plate 21D) will attempt to deform by bending upwards. However, hollow portion H1 in under-panel 20 is divided into multiple sections by vertical walls connecting upper plate 21U and lower plate 21D so that the vertical walls are disposed and connect upper plate 21U and lower plate 21D at various locations along the vehicle longitudinal direction. Therefore, the bending strength of under-panel 20 is relatively high, and the deformation amount of under-panel 20 bending upwards is small. This means that under-panel 20 absorbs the impact energy from the road-surface side under vehicle 1, protecting battery pack 10.

In other words, if road-surface interference object N interferes with the lower part of vehicle 1, under-panel 20 protects battery pack 10 from the load input from road-surface interference object N.

On the other hand, as shown in FIG. 11, when vehicle 1 side-collides with pole P, for example, an impact load is input to the left side of the pair of side members 1S. Hence, left side member 1S plastically deforms and moves inward in the vehicle width direction, transmitting part of the input impact load to under-panel 20.

Here, under-panel 20 is disposed to span between the pair of side members 1S, so the impact load input to left side member 1S is transmitted to right side members 1S via under-panel 20. This disperses the impact energy input to left side member 1S to right side member 1S as well. As a result, the deformation of left side member 1S due to the impact load is suppressed. In other words, this allows the impact load acting on the side of battery pack 10 through the deformation of left side member 1S to be mitigated.

Dotted line α1 in FIG. 11 shows the deformation mode of left side member 1S when under-panel 20 is not disposed between the pair of side members 1S. On the other hand, dotted line α2 shows the deformation mode of left side member 1S when under-panel 20 is disposed between the pair of side members 1S.

Furthermore, even in this case, since the bending strength of under-panel 20 is relatively strong, the amount of deformation of under-panel 20 is relatively small, and the impact energy input to left side member 1S is widely dispersed to right side member 1S.

In other words, the presence of under-panel 20 allows battery pack 10 to be protected from the impact load input when vehicle 1 side-collides with pole P.

### Effects

As described above, this embodiment discloses a battery mounting structure of an EV vehicle, comprising: a plurality of panel components that are disposed below a floor panel of the vehicle and extend in a vehicle width direction so as to span between a pair of side members of a vehicle frame respectively, wherein the panel components are connected in a line along a vehicle longitudinal direction to constitute an under-panel that serves as a mounting base for a battery pack.

According to the battery mounting structure of the EV vehicle in this embodiment, it is possible to mitigate the impact load from outside the vehicle to the battery pack and protect the battery pack. Additionally, this configuration can prevent damage to the battery from fire exposure from below.

Moreover, since the under-panel in this embodiment is constructed by connecting a plurality of panel components, it can be made into a large size capable of mounting a long-size battery pack. According to this configuration, by adjusting the number of panel components, the length of the under-panel in the vehicle longitudinal direction can be adjusted, making it applicable to vehicles with various wheelbases.

Although the specific examples of the present invention have been described in detail above, these are merely examples and do not limit the scope of the claims. The technology described in the claims includes various modifications and changes of the specific examples exemplified above.

The present application is entitled to the benefit of Japanese Patent Application No. 2024-217640, filed on Dec. 12, 2024, the disclosure of which including the specification, drawings and abstract is incorporated herein by reference in its entirety.

### INDUSTRIAL APPLICABILITY

According to the battery mounting structure of the EV vehicle of the present invention, it is possible to reduce the impact load on the battery pack from outside the vehicle and protect the battery pack.

### REFERENCE SIGNS LIST

1. Vehicle
Ca. Battery mounting structure
1F. Floor Panel
1S. Side member
1T. Cross Member
1WB. Rear Wheels
1WF. Front Wheels
10. Battery Pack
20. Under-panel
21. Panel component

1. A battery mounting structure of an EV vehicle, comprising:
a plurality of panel components that are disposed below a floor panel of the vehicle and extend in a vehicle width direction so as to span between a pair of side members of a vehicle frame respectively,
wherein the panel components are connected in a line along a vehicle longitudinal direction to constitute an under-panel that serves as a mounting base for a battery pack.

2. The battery mounting structure according to claim 1, wherein the under-panel occupies an area of at least half a length between a position of a front wheel and a position of a rear wheel of the vehicle within an area between the pair of side members in the vehicle longitudinal direction.

3. The battery mounting structure according to claim 1, wherein no cross member spanning between the pair of side members is provided in an area where the under-panel is provided.

4. The battery mounting structure according to claim 1, wherein each of the panel components has an upper plate and a lower plate, and the upper plate and the lower plate are connected so as to form a hollow portion extending along the vehicle width direction therebetween.

5. The battery mounting structure according to claim 4, wherein the hollow portion is divided into multiple sections by vertical walls disposed at various locations along the vehicle longitudinal direction, the vertical walls each connecting the upper plate and the lower plate.

6. The battery mounting structure according to claim 1, wherein each of the panel components has either an insertion protrusion or a gripping recess at both ends in the vehicle longitudinal direction, and adjacent panel components among the panel components are welded and fixed together in a state where the insertion protrusion of one panel component is fitted into the gripping recess of the other panel component.

7. The battery mounting structure according to claim 6, wherein the vertical thickness at the end of each of the panel components in the vehicle longitudinal direction is thinner than the vertical thickness at the center of each of the panel components.

8. The battery mounting structure according to claim 1, wherein each of the panel components is integrally formed from aluminum extrusion material.

9. The battery mounting structure according to claim 1, wherein the panel components are fixed to lower sides of the pair of side members with bolts on both sides in the vehicle width direction.

10. The battery mounting structure according to claim 1, wherein the under-panel is disposed so as to cover substantially an entire lower surface of the battery pack.

11. The battery mounting structure according to claim 1, wherein the battery pack is mounted on the under-panel and disposed in an area between the pair of side members.
